(19) United States
(12) Patent Application Publication
(10) Pub. No.: US 2013/0200059 A1
(43) Pub. Date: Aug. 8, 2013

(54) HAND TOOL CENTERING DEVICES AND METHODS

(71) Applicant: Mervyn Rudgley, Mission Viejo, CA (US)

(72) Inventor: Mervyn Rudgley, Mission Viejo, CA (US)

(21) Appl. No.: 13/637,076

(22) PCT Filed: Mar. 25, 2011
(86) PCT No.: PCT/US11/30010

§ 371 Date: Oct. 15, 2012

Related U.S. Application Data
(60) Provisional application No. 61/318,178, filed on Mar. 26, 2010.

(51) Int. Cl. B23Q 16/00

(52) U.S. Cl. CPC B23Q 16/00
USPC 219/158

(57) ABSTRACT

Devices and methods for centering a hand tool relative to a fastener, including a sighting guide for providing a reference for the location of a centering tool relative to the fastener. The centering tool may include a reception to enhance sighting and facilitate interoperability with additional viewing devices and hand tools for operating on the fastener.

### RELATED APPLICATIONS

This application claims the full Paris Convention benefit of and priority to U.S. Provisional Patent Application Ser. No. 61/318,178, filed Mar. 26, 2010, the contents of which are incorporated by reference herein in its entirety, as if fully set forth herein.

This application incorporates by reference U.S. application Ser. No. 12/603,507, filed Oct. 21, 2009, as if fully set forth herein.

### BACKGROUND

1. Field

This disclosure relates to devices and methods for centering hole or cut producing hand tools relative to a workpiece.

### SUMMARY

According to some exemplary implementations, disclosed is a hand tool centering device, comprising: an interface configured to be placed against a surface. In some instance the surface is of a workpiece, which may be a frame, and said frame contains a fastener; a sighting guide comprising a circular opening having an inner diameter at least substantially equal to the outer diameter of a fastener, wherein the circular opening is configured to visually facilitate a concentric alignment with the outer diameter of the fastener; and a reception exposing the sighting guide to a top portion of the hand tool centering device and configured to accept at least a tip of a hand tool. In some instance the fastener may be a flat-head fastener having a surface substantially flush with the surface.

According to some exemplary implementations, disclosed is a hand tool centering device, with a reception that may have a geometry corresponding to a geometry of the tip of a hand tool. The reception may be configured to align the central axis of the tip of a hand tool with a central axis of the fastener. The hand tool may be a plasma erosion device. The central axis of the tip of a hand tool may correspond to the principal axis of an erosion electrode. At least a portion of the reception between the top portion and circular opening may taper inwardly.

According to some exemplary implementations, disclosed is a hand tool centering device, comprising: an interface configured to be placed against a surface=a fastener; a reception configured to accept each of a viewer and a tip of a hand tool; and a viewer comprising a sighting guide disposed at a bottom end of the view and configured to visually facilitate a concentric alignment with the outer diameter of the fastener. In some instance the sighting guide may be a plurality of concentric circles. In some instances the fastener may be a flat-head fastener being substantially flush with said surface of the workpiece (which may be a frame). The reception may have a geometry corresponding to each of a geometry of the viewer and a geometry of the tip. The reception may be configured to align the central axis of the tip of a hand tool with a central axis of the fastener. The geometry of the reception and the geometry of the viewer may cause the sighting guide of the viewer to be substantially coplanar with the surface when the viewer is mated within the reception. The viewer may further comprise a lens configured to refract an image of the sighting guide away from a central axis of the viewer. The hand tool may produce a plasma to disintegrate boluses of material. The central axis of the tip of a hand tool may correspond to the principal axis of an erosion electrode.

According to some exemplary implementations, disclosed is a method of centering a hand held EDM device, comprising: providing a centering device having a reception to a surface of a frame containing a fastener; aligning a central axis of the centering device with a central axis of the fastener; and mating the tip of a hand tool within the reception of the centering device, whereby a central axis of the tip is aligned with the central axis of the fastener. In some instance the mating between the tip and reception forms a seal.

Aligning a central axis of the centering device with a central axis of the fastener may comprise: concentrically aligning a circular opening disposed at the bottom end of the reception with an outer diameter of the fastener. Aligning a central axis of the centering device with a central axis of the fastener may comprise: providing a viewer to the reception, the viewer having a sighting guide; aligning the sighting guide with an outer diameter of the fastener; and removing the viewer from the reception. The method may further comprise: eroding at least a portion of the fastener with the hand tool. The fastener may be a flat-head fastener having a surface flush with the surface of a workpiece which may include a frame, skin or coating over a frame and the like.

### DRAWINGS

The above-mentioned features and objects of the present disclosure will become more apparent with reference to the following description taken in conjunction with the accompanying drawings wherein like reference numerals denote like elements and in which:

FIG. 1A shows a plan view of a base;

FIG. 1B shows a sectional view of a base;

FIG. 1C shows a perspective view of a base;

FIG. 1D shows a perspective view of a base;

FIG. 1E shows a top view of a base;

FIG. 1F shows a bottom view of a base;

FIG. 2A shows a sectional view of a base approaching a fastener;

FIG. 2B shows a sectional view of a base on a fastener;

FIG. 3A shows a view of a viewer;

FIG. 3B shows a perspective view of a viewer;

FIG. 3C shows a perspective view of a viewer;

FIG. 4A shows a plan view of a viewer approaching a base;

FIG. 4B shows a sectional view of a viewer approaching a base;

FIG. 4C shows a perspective view of a viewer approaching a base;

FIG. 4D shows a perspective view of a viewer approaching a base;

FIG. 4E shows a top view of a viewer approaching a base;

FIG. 4F shows a bottom view of a viewer approaching a base;

FIG. 5A shows a plan view of a viewer within a base;

FIG. 5B shows a sectional view of a viewer within a base;

FIG. 5C shows a perspective view of a viewer within a base;

FIG. 5D shows a perspective view of a viewer within a base;

FIG. 5E shows a top view of a viewer within a base;

FIG. 5F shows a bottom view of a viewer within a base;

FIG. 6A shows a sectional view of a viewer within a base approaching a fastener;

FIG. 6B shows a perspective view of a viewer within a base on a fastener;

FIG. 7A shows a plan view of a tip approaching a base;

FIG. 7B shows a sectional view of a tip approaching a base;

FIG. 7C shows a perspective view of a tip approaching a base;

FIG. 7D shows a perspective view of a tip approaching a base;

FIG. 7E shows a top view of a tip approaching a base;

FIG. 7F shows a bottom view of a tip approaching a base;

FIG. 8A shows a plan view of a tip within a base;

FIG. 8B shows a sectional view of a tip within a base;

FIG. 8C shows a perspective view of a tip within a base;

FIG. 8D shows a perspective view of a tip within a base;

FIG. 8E shows a top view of a tip within a base;

FIG. 8F shows a bottom view of a tip within a base;

FIG. 9A shows a sectional view of a tip approaching a base;

FIG. 9B shows a sectional view of a tip approaching a base;

FIG. 9C shows a sectional view of a tip within a base;

FIG. 10A shows a sectional view of a tip approaching a base;

FIG. 10B shows a sectional view of a tip approaching a base; and

FIG. 10C shows a sectional view of a tip within a base.

### DETAILED DESCRIPTION

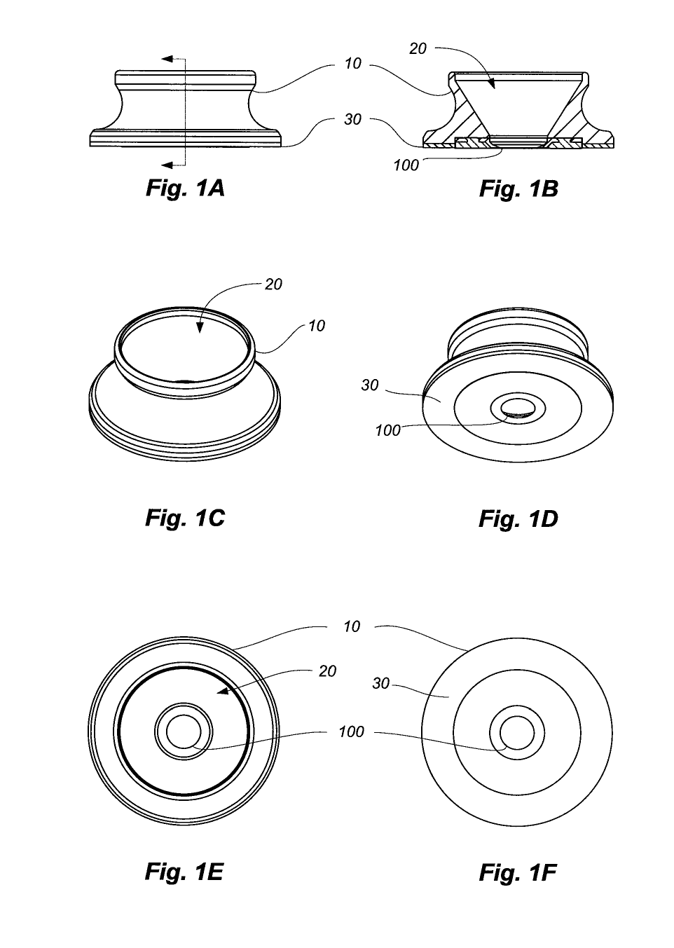

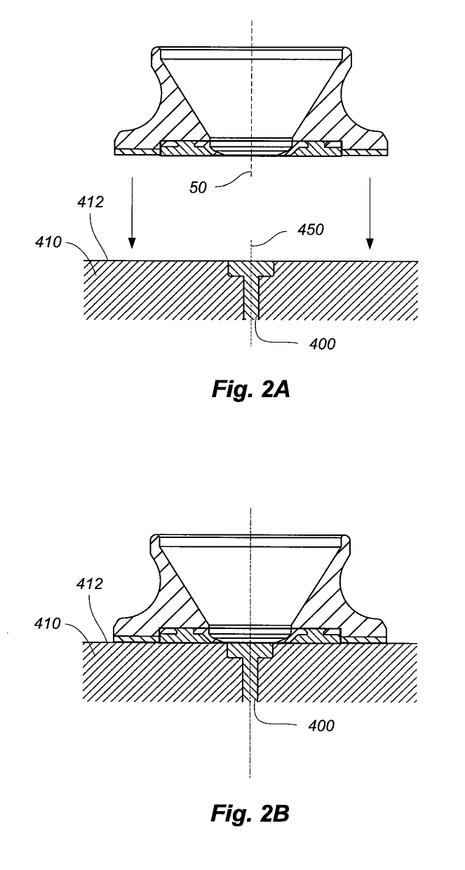

According to some exemplary implementations, hand tool centering devices and methods are disclosed herein. According to some exemplary implementations, base 10 may be provided, as shown in FIGS. 1A, 1B, 1C, 1D, 1E, and 1F. Base 10 may include sighting guide 100. For example, sighting guide 100 may be a circle, crosshair, reticle, dot, bar, chevron, steps, etc. Sighting guide 100 may be configured to visually facilitate a concentric alignment of base 10 with the outer diameter of fastener 400. For example, as shown in FIGS. 2A and 2B, central axis 50 of base 10 may be caused to be aligned with central axis 450 of fastener 400.

As shown in FIGS. 1B, 1D, and 1F, sighting guide 100 may be a circular opening at the bottom end of base 10 and reception 20. The circular opening may have an inner diameter at least substantially equal to an outer diameter of fastener 400, as shown in FIGS. 2A and 2B.

According to some exemplary implementations, reception 20 may expose sighting guide 100 to a top portion of reception 20 or of base 10. Accordingly, a user may view from beyond the top portion into reception 20, for example to view at least sighting guide 100 and fastener 400. At least a portion of reception 20 between the top portion and circular opening may taper or step inwardly, such that the entirety of the circular opening may be viewable from angles other than along the central axis of base 10. Likewise, such a feature may improve visualization of fastener 400.

According to some exemplary implementations, base 10 may include interface 30 configured to be placed against surface 412 which may be the surface of a frame 410 containing a fastener 400.

According to some exemplary implementations, fastener 400 may be any variety of fastener, object, or material to be acted upon. According to some exemplary implementations, fastener 400 may be a flat-head (non-protruding) fastener, such that little or no structure is available as a reference for centering of a hand tool, as shown in FIGS. 2A and 2B. In contrast, a protruding-head fastener may provide structure extending beyond a surface that may provide a reference for relative location or orientation of a tool to operate thereon. For example, mechanical operations may be performed based on the protrusion to position or orient a tool. Implementations of the present disclosure may be particularly (but not exclusively) useful for flat-head (non-protruding) fasteners.

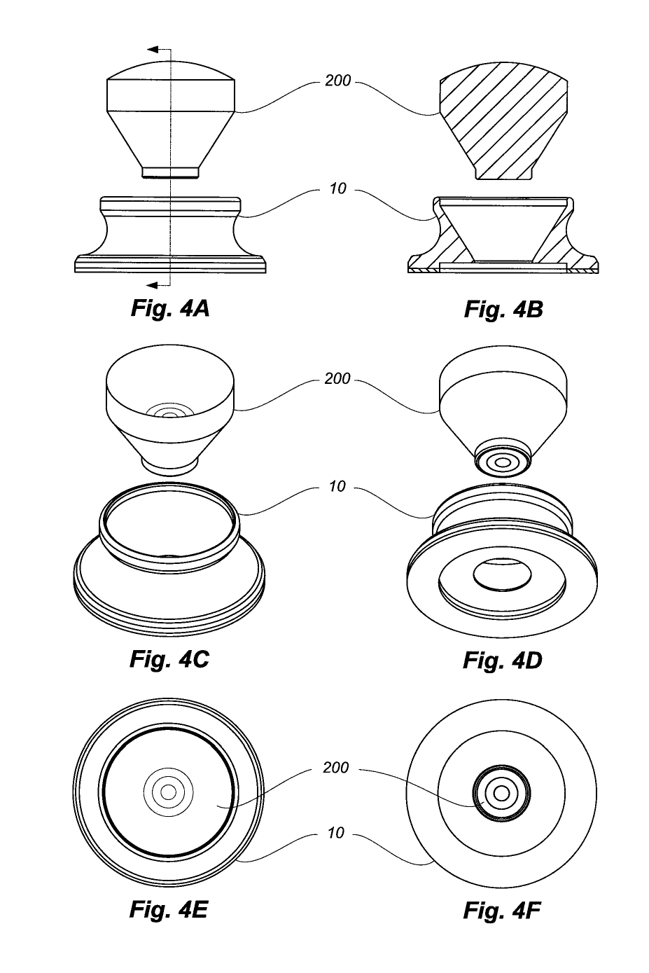

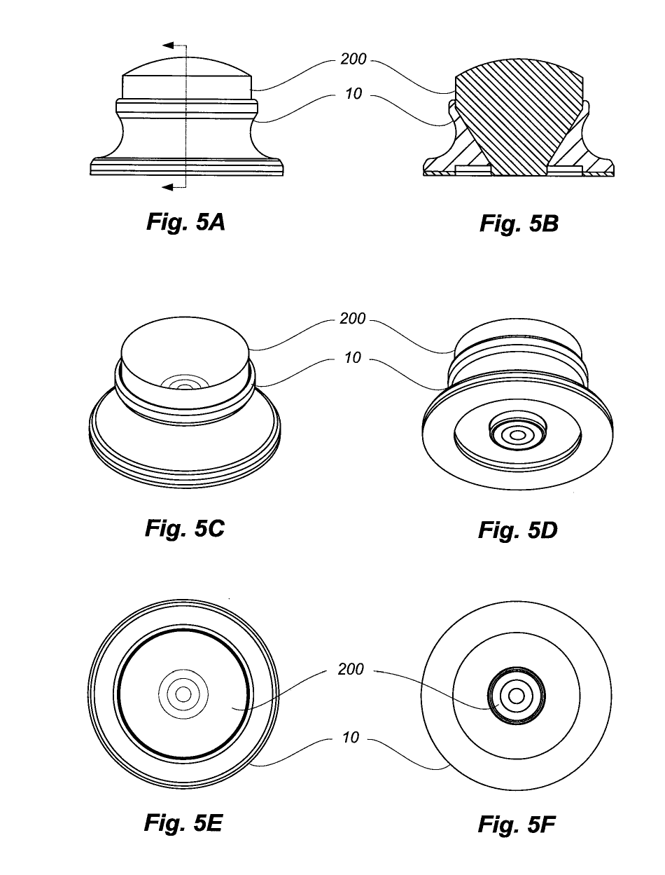

According to some exemplary implementations, viewer 200 may be provided to enhance centering of base 10, as shown in FIGS. 4A, 4B, 4C, 4D, 4E, 4F, 5A, 5B, 5C, 5D, 5E, and 5F.

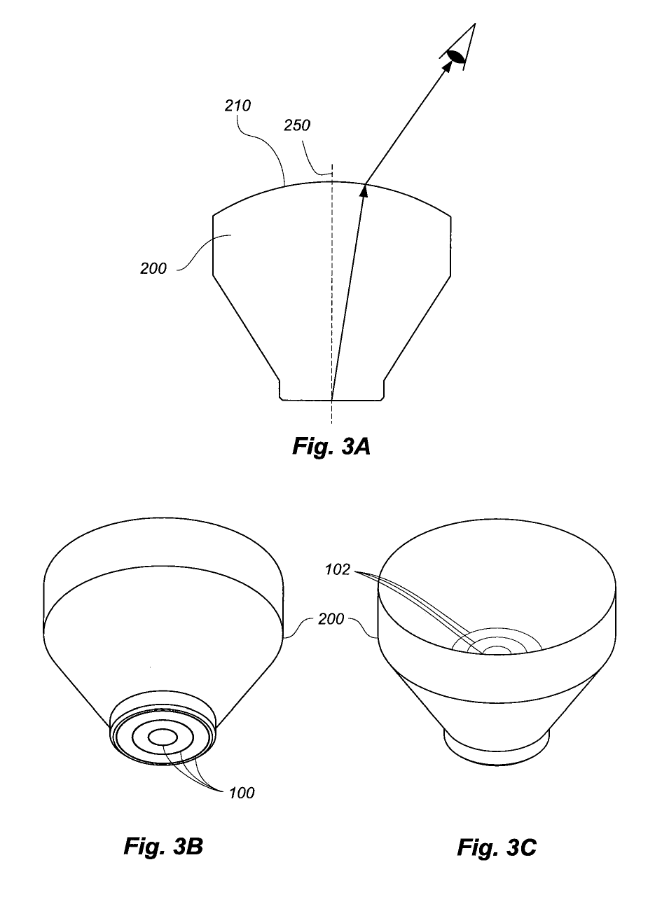

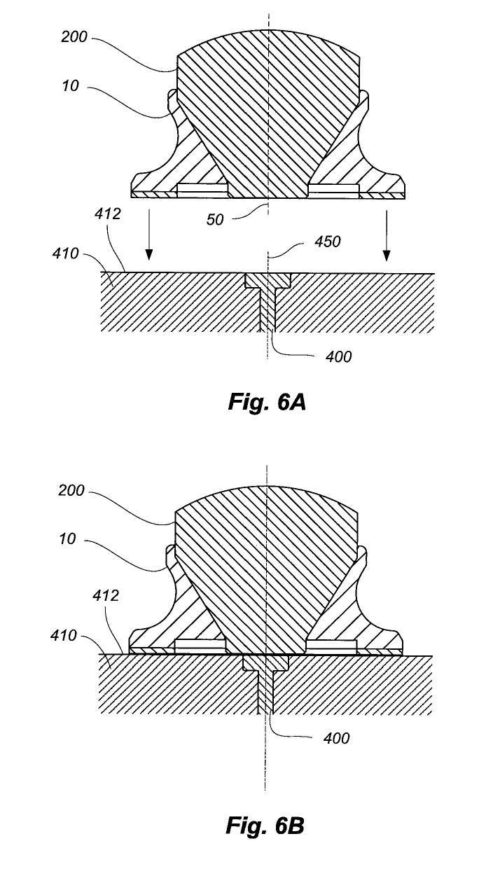

According to some exemplary implementations, and as shown in FIGS. 3A, 3B, and 3C, a removable viewer 200 may include sighting guide 100. Sighting guide 100 may be disposed at a bottom end of viewer 200 and configured to visually facilitate a concentric alignment with the outer diameter of fastener 400. The shape and geometry of reception 20 and the shape and geometry of viewer 200 may cause sighting guide 100 to be substantially coplanar with surface 412 when viewer 200 is mated within reception 20, as shown in FIGS. 6A and 6B.

According to some exemplary implementations, viewer 200 may be transparent or translucent, such that sighting guide 100 disposed at a bottom end thereof may be viewable from beyond a top end thereof. As shown in FIG. 3A, viewer may include lens 210. Lens 210 may be separate from or integral with any other portion of viewer 200. As further shown in FIG. 3A, Lens 210 may be configured to refract image 102 of sighting guide 100 away from a central axis 250 of viewer 200. For example, lens 210 may be a convex surface where sighting guide 100 has an index of refraction greater than 1. As shown in FIG. 3C, this may allow image 102 of sighting guide 100 to be viewed without having a direct view to the actual location of sighting guide 100. Further, such a feature reduces errors that may arise from viewing sighting guide 100 from angles other than aligned with central axis 250 of viewer 200. For example, errors may arise where sighting guide 100 is not viewed along central axis 250, in that the relative locations of sighting guide 100 and fastener 400 may not appear as the really are. The refraction provided by lens 210 reduces the error introduced by sighting at an angle other than along central axis 250. At least a portion of base 10 may be configured to interface with a surface to facilitate placement and maintenance of location of base 10 relative to the surface when base 10 is pressed against or near the surface.

According to some exemplary implementations, base 10 and viewer 200 may be provided to fastener 400 to align central axis 50 of base 10 with central axis 450 of fastener 400.

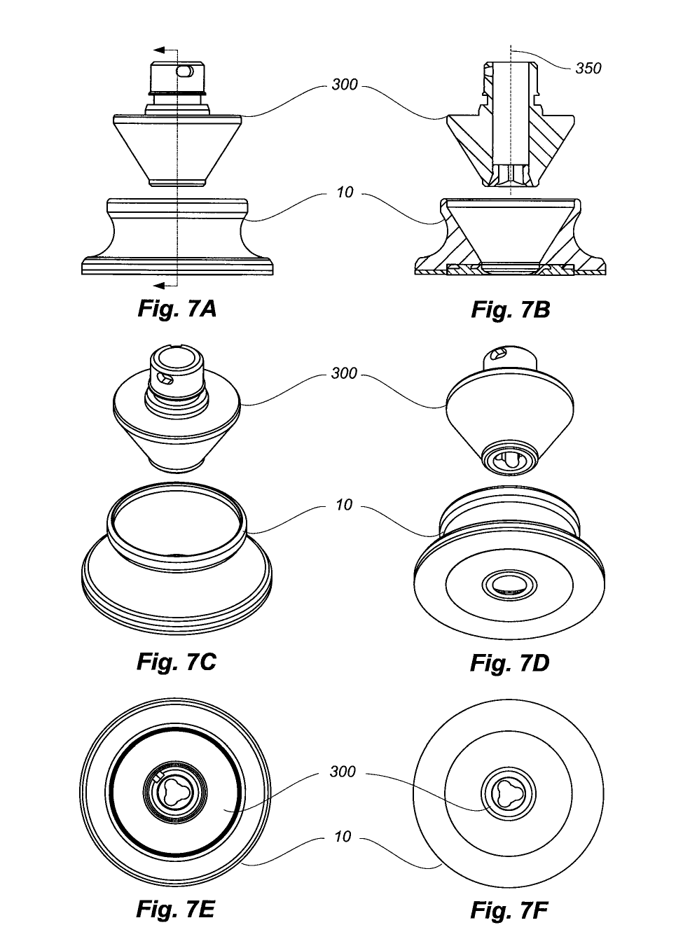

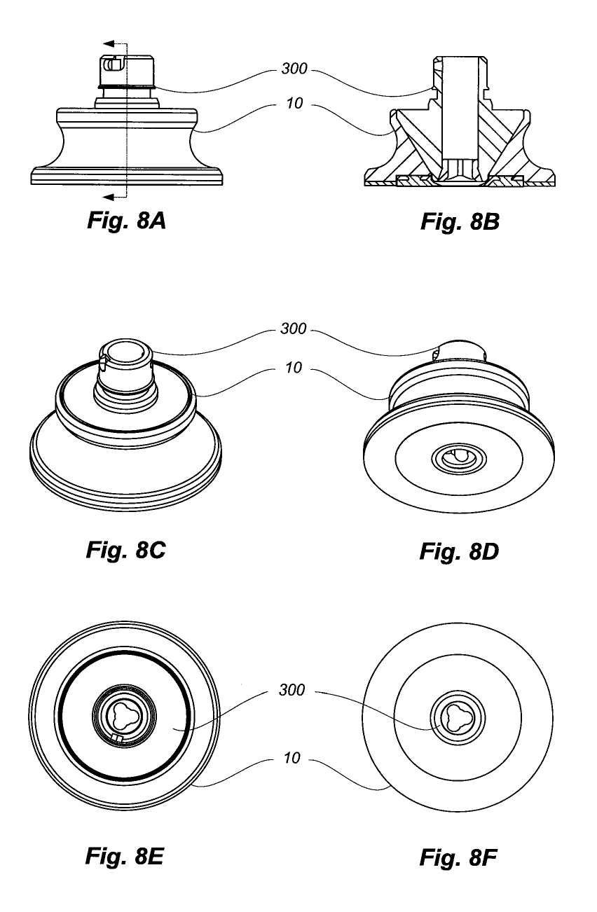

According to some exemplary implementations, reception 20 may be configured to accept both a viewer 200 and at least tip 300 of a hand tool, as shown in FIGS. 7A, 7B, 7C, 7D, 7E, 7F, 8A, 8B, 8C, 8D, 8E, and 8F. Accordingly, a geometry of reception 20 may correspond to tip 300, such that when tip 300 is engaged within reception 20, the respective central axes are aligned.

According to some exemplary implementations, the hand tool may be any device configured to operate on fastener 400. Examples include those devices that would benefit from alignment along central axis 450 of fastener 400. According to some exemplary implementations, the hand tool may be an EDM device. The EDM device may be used to erode at least a portion of fastener 400. Such erosion may be forceless and precision-based relative to the alignment provided by centering devices and methods disclosed herein. An erosion electrode may have a principal axis and be advanceable along the same. The principal axis may be aligned with central axis 350 of tip 300.

According to some exemplary implementations, disclosed is a method of aligning a hand tool with fastener 400. As shown in FIGS. 2A, 2B, 6A, and 6B, at least base 10 may be provided to surface 412 of a workpiece or frame 410 containing fastener 400. Central axis 50 of base 10 may be aligned with central axis 450 of fastener 400. This may include aligning sighting guide 100 relative to fastener 400.

According to some exemplary implementations, where a circular opening is provided, aligning central axis 50 of base 10 with central axis 450 of fastener 400 may comprise concentrically aligning the circular opening with fastener 400.

According to some exemplary implementations, a method of alignment wherein viewer 200 is provided to reception 20. Sighting guide 100 of viewer 200 may be aligned with fastener 400, whereby central axis 50 of base 10 is aligned with central axis 450 of fastener 400. Viewer 200 may then be removed from reception 20 while maintaining the placement of the base 10 tip 300 may be inserted. According to some exemplary implementations, tip 300 of a hand tool may be engaged within reception 20 of base 10, whereby central axis 350 of tip 300 is aligned with central axis 450 of fastener 400. The tip 300 of the hand tool is illustrated fitted or mated into the reception 20 (as shown in FIGS. 8A through 10C). The more exact the fit the better the seal formed between the tip 300 and the reception 20.

According to some exemplary implementations, the hand tool may be used while tip 300 is engaged within reception 20. For example, at least a portion of fastener 400 may be eroded with the hand tool. Electro-discharge devices, systems, and methods as disclosed in U.S. application Ser. No. 12/603,507, filed Oct. 21, 2009, may be applied, wherein a plasma is generated in conjunction with a dielectric to erode and/or disintegrate boluses of material in a controlled fashion.

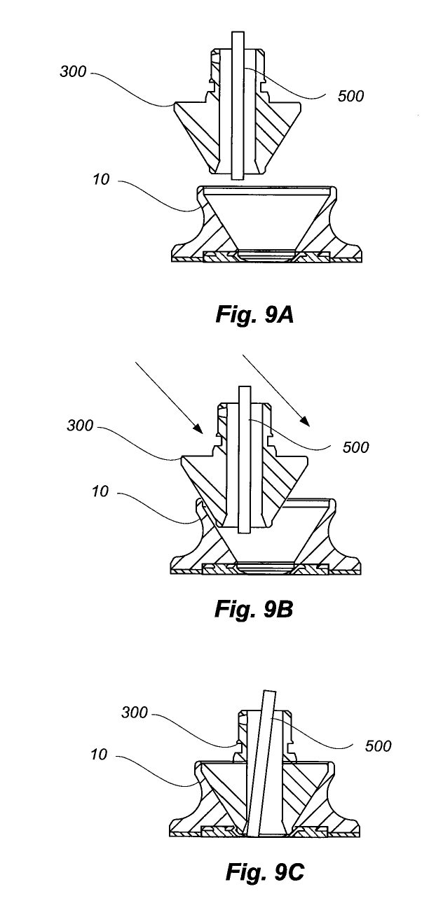

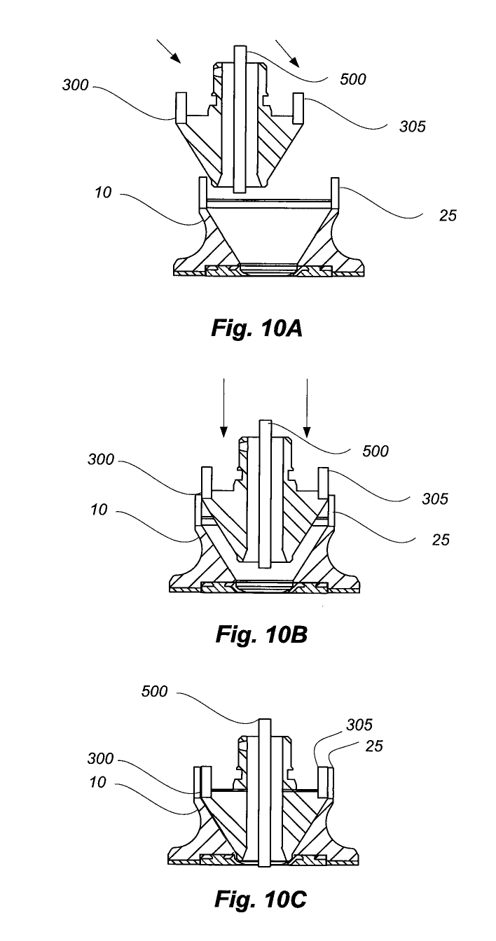

According to some exemplary implementations, use of pin 500 may benefit from the disclosure herein. As shown in FIGS. 9A, 9B, 9C, 10A, 10B, and 10C, pin 500 may be within tip 300 and be configured for alignment with fastener 400. Pin 500 may be an electrode of an EDM device or other component of a device to act on fastener 400. Pin 500 may be spring-loaded or otherwise configured to come into contact with fastener 400 when tip 300 is engaged within base 10. Operation of pin 500 may be at least somewhat dependent on alignment with fastener 400.

According to some exemplary implementations, as shown in FIGS. 9A, pin 500 may naturally be in an aligned state, in which it is parallel to the alignment ultimately desired. As shown in FIG. 9B, advancement of tip 300 to an engaged position within base 10 may be other than orthogonal to surface 412 or fastener 400, inter alia. For example, where reception 20 is tapered, a user may have a tendency to advance tip 30 along one side of the taper, as shown in FIG. 9B. In such a scenario, pin 500 may be brought into contact with fastener 400 or surface 412 while such non-orthogonal motion is occurring. The result is shown in FIG. 9C, wherein pin 500 is shifted away from its original axis of alignment.

According to some exemplary implementations, as shown in FIGS. 10A, 10B, and 10C, tip 300 may have vertical siding 305, and base 10 may have vertical wall 25. The designation of “vertical” indicates that the surfaces of vertical siding 305 and vertical wall 25 are parallel to the intended alignment of at least one of tip 300 and pin 500. For example, as shown in FIG. 10A, tip 300 may be advanced in a non-orthogonal manner. However, as shown in FIG. 10B, as vertical siding 305 of tip 300 falls within vertical wall 25 of base 10, only orthogonal advancement may be permitted. Such limitation to orthogonal advancement prior to contacting pint 500 with fastener 400 or surface 412 may allow pin 500 to maintain orthogonality as tip 300 becomes fully engaged within reception 20 of base 10, as shown in FIG. 10C.

According to some exemplary implementations, vertical siding 305 of tip 300 and vertical wall 25 of base 10 may align as tip 300 advances within reception 20. Accordingly, vertical siding 305 and vertical wall 25 may be at a top portion (as shown in FIGS. 10A, 10B, and 10C), bottom portion, or middle portion (or combinations thereof) of tip 300 and base 10, respectively.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the disclosure and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A hand tool centering device, comprising:
an interface configured to be placed against a workpiece surface containing a fastener;
a sighting guide comprising a circular opening having an inner diameter at least substantially equal to the outer diameter of a fastener, wherein the circular opening is configured to visually facilitate a concentric alignment with the outer diameter of the fastener; and,
a reception exposing the sighting guide to a top portion of the hand tool centering device and configured to accept at least a tip of a hand tool.

2. The hand tool centering device of claim 1, wherein the fastener is a flat-head fastener having a surface substantially flush with the surface.

3. The hand tool centering device of claim 1, wherein the reception has a geometry corresponding to a geometry of the tip.

4. The hand tool centering device of claim 3, wherein the reception is configured to align the central axis of the tip of a hand tool with a central axis of the fastener.

5. The hand tool centering device of claim 1, wherein the hand tool is a plasma erosion device.

6. The hand tool centering device of claim 5, wherein the central axis of the tip of a hand tool corresponds to the principal axis of an erosion electrode.

7. The hand tool centering device of claim 1, wherein at least a portion of the reception between the top portion and circular opening tapers inwardly.

8. A hand tool centering device, comprising:
an interface configured to be placed against a surface of a frame containing a fastener;
a reception configured to accept each of a viewer and a tip of a hand tool; and,
a viewer comprising a sighting guide disposed at a bottom end of the view and configured to visually facilitate a concentric alignment with the outer diameter of the fastener.

9. The hand tool centering device of claim 8, wherein the sighting guide is a plurality of concentric circles.

10. The hand tool centering device of claim 8, wherein the fastener is a flat-head fastener having a surface flush with the frame.

11. The hand tool centering device of claim 8, wherein the reception has a geometry corresponding to each of a geometry of the viewer and a geometry of the tip.

12. The hand tool centering device of claim 11, wherein the reception is configured to align the central axis of the tip of a hand tool with a central axis of the fastener.

13. The hand tool centering device of claim 11, wherein the geometry of the reception and the geometry of the viewer cause the sighting guide of the viewer to be substantially coplanar with the surface of the frame when the viewer is mated within the reception.

14. The hand tool centering device of claim 8, wherein the viewer further comprises a lens configured to refract an image of the sighting guide away from a central axis of the viewer.

15. The hand tool centering device of claim 8, wherein the hand tool produces a plasma to disintegrate boluses of material.

16. The hand tool centering device of claim 15, wherein the central axis of the tip of a hand tool corresponds to the principal axis of an erosion electrode.

17. A method of centering a hand held EDM device, the method comprising:
providing a centering device having a reception to a surface of a frame containing a fastener;
aligning a central axis of the centering device with a central axis of the fastener; and,
engaging a tip of a hand tool within the reception of the centering device, whereby a central axis of the tip is aligned with the central axis of the fastener.

18. The method of claim 17, wherein aligning a central axis of the centering device with a central axis of the fastener comprises:
concentrically aligning a circular opening disposed at the bottom end of the reception with an outer diameter of the fastener.

19. The method of claim 17, wherein aligning a central axis of the centering device with a central axis of the fastener comprises:
providing a viewer to the reception, the viewer having a sighting guide;
aligning the sighting guide with an outer diameter of the fastener; and,
removing the viewer from the reception.

20. The method of claim 17, the method further comprising: eroding at least a portion of the fastener with the hand tool.

21. The method of claim 17, wherein the fastener is a flat-head fastener having a surface flush with the surface of the frame.
